(19) United States
(12) Patent Application Publication
(10) Pub. No.: US 2014/0265709 A1
(43) Pub. Date: Sep. 18, 2014

(54) Steered Flux Generator

(71) Applicant: Arizona Digital, Inc., Sisters, OR (US)

(72) Inventor: Andrew Berding, Sisters, OR (US)

(73) Assignee: Arizona Digital, Inc., Sisters, OR (US)

(21) Appl. No.: 14/199,713

(22) Filed: Mar. 6, 2014

Related U.S. Application Data
(60) Provisional application No. 61/780,593, filed on Mar. 13, 2013.
(60) Provisional application No. 61/794,644, filed on Mar. 15, 2013.

(51) Int. Cl. H02K 19/16

(52) U.S. Cl. CPC H02K 19/16
USPC 310/168

(57) ABSTRACT

The present invention relates to the field of electrical power generators. Structures of the present invention involve the use of steered flux and comprise uniquely simplified and efficient structures, including rotors free of windings and magnets, and stators with coils encircling, not individual stator poles, but multiple poles or the rotor itself. Magneto Motive Force used with the present invention can be provided by either self-bias or external-bias, including superconducting magnets. The present invention may involve the use of unipolar flux. The many embodiments of the present invention capitalize on innovative approaches to and reconfigurations of electrical power generation principles and structures.

### RELATED APPLICATIONS

This application claims priority to U.S. provisional patent application Ser. Nos. 61/780,593 filed on Mar. 13, 2013, and 61/794,644 filed on Mar. 15, 2013, the contents of which are fully incorporated herein by reference.

### BACKGROUND OF THE INVENTION

1. Field of the Invention

The present invention relates to the field of electrical power generators. Structures of the present invention involve the use of steered flux and comprise uniquely simplified and efficient structures, including rotors free of windings and magnets, and stators with coils encircling, not individual stator poles, but multiple poles or the rotor itself. Various embodiments of the present invention use unipolar flux. The present invention structures capitalize on innovative approaches and reconfigurations of electrical power generation principles.

2. Description of Related Art

Conventional electrical power generators (CEPGs) have limited efficiency.

Efficiency losses result in revenue losses because there is less energy to sell. Due to inefficiencies in CEPGs, larger equipment may be needed to supply the required output power. Lost energy typically shows up as heat within the generator which, in turn, requires cooling. Such heat also negatively impacts equipment reliability and its effective lifetime.

CEPGs utilize bipolar flux and require a rotating magnetic field generated by a magnetized rotor. Conventional rotors are magnetized by either permanent magnets, or by turning the rotor into multiple electromagnets via the inclusion of field windings. Permanent magnets can be advantageous because they require zero power to produce the magnetic field, and are simple and efficient. Permanent magnets, however, are very expensive, use scarce strategic materials, produce limited maximum obtainable fields, are adhered to the rotor and, thus, can come loose with catastrophic results, and can become demagnetized under short-circuit fault conditions.

Conventional large 2.5 megawatt windmills may use up to 700 pounds of permanent magnets. Because of the above-noted disadvantages associated with permanent magnets, however, most large generators have field windings on the rotor.

Rotor field windings are a well-known technology and can produce large required fields. In practice, however, the maximum field cannot be optimized due to space restrictions triggered by required windings and by winding power dissipation.

Additionally, field windings further diminish CEPG efficiency because they require cooling, are difficult and expensive to wind, can come loose with catastrophic results, require a source of direct current (DC) electrical power (usually provided by slip rings and brushes), and field winding failures, alone or together with insulation failures, limit equipment lifetime.

CEPGs operate on the principle that North and South magnetic poles on the spinning rotor (created by permanent magnets or field windings) couple to high-permeability laminations on the stator around which copper wire has been wound. In order to minimize copper losses, most large CEPGs use square wire rather than round wire. In some large CEPGs, the power losses are so large that they have to use tubular windings and pump cooling de-ionized water through the windings.

As shown in FIG. 3, stator laminations operate in quadrants I and III of the BH loop. This flux is bipolar during a complete rotor cycle, i.e., it changes direction.

First the rotor's North pole couples with a given stator pole producing a magnetizing force H₁. This magnetizing force, divided by the reluctance R₁ in the magnetic circuit, results in a flux φ₁. Flux φ₁ divided by the pole cross-sectional area results in a flux density B₁. Half a cycle later, the rotor's South pole couples with that same stator pole producing a magnetizing force H₂. This magnetizing force, divided by the reluctance R₂, results in a flux φ₂. Flux φ₂ divided by the pole's cross-sectional area results in a flux density B₂. Since usually H₁=−H₂, and R₁=R₂, then B₁=−B₂ which means that φ₁=φ₂.

Alternating voltage produced in a coil wound around the pole is described by the simple equation V_{ac}=N*Δφ/ΔT, where N is the number of turns of wire, Δφ is the change in flux (φ₁−φ₂=2*φ), and ΔT is the interval of time in which that occurs (half of a full cycle; ΔT=1/(2*f) where f is the frequency).

Conventionally, output voltage is generated by coupling the changing magnetic flux Δφ with the stator's copper windings. To accomplish this coupling, CEPGs wind the wire around the laminations of each stator pole and then expose the windings to a changing magnetic flux caused by the magnetized rotor's rotation. Because CEPGs include stators with many poles, the resulting structures are very complex and require lots of wire.

FIGS. 1A and 1B shows a prior art rotor comprising stacked stamped laminations [6] with overlapping coils of windings [4] inserted into the slots [8] between rotor poles [12] The rotor is driven by the shaft [32]. Slip rings [14] and brushes [16] provide magnetizing current to the windings [4] which are wound around the laminations [6]. It is difficult to pre-form the windings [4], insert them into the slots [8], wedge them so that they do not fly out, protect them so the sharp edges of the laminations [6] do not cut into the insulation on the wire and keep them from vibrating so that they do not abrade the insulation on the wire. It is also difficult to achieve a good “fill factor” wherein the slot area is efficiently filled with windings. Also, the windings [4] can come loose catastrophically. Windings [4] bend around sharp edges of the laminations [6] and can vibrate and rub the insulation. Furthermore, heat created by windings [4] resistance deteriorates the insulation and can lead to premature failure. Furthermore, the space required by windings [4] reduces the available laminations' [6] cross-sectional area which, in turn, reduces the flux and, thus, generator power output.

Further, the windings' end portions [18] outside the slots [8] result in energy loss and contribute nothing to the power output. Due to this complex configuration, these end portions [18] are necessary in order to complete wrapping the wire around the poles [12]. Sometimes, there is as much wire in the end portions [18] as there is within the slots [8]. Another reason that end portions [18] cause loss is because they have aerodynamic drag (friction). Slip rings [14] and brushes [16] wear and they spark which causes Radio Frequency Interference (RFI) and inductive voltage spikes that can damage the insulation on the wire.

CEPG stators (see FIGS. 2A and B) consist of stacked stamped laminations [58] with overlapping wire windings [62] inserted into the slots [64] between stator poles [66]. It is very difficult to pre-form the windings [62], insert them into the slots [64], wedge them in so that they do not come loose, protect them so that the sharp edges of the laminations [58] do not cut into the insulation on the wire, and keep them from vibrating so that they do not abrade the insulation on the wire. It is also difficult to achieve a good “fill factor” wherein the slot [64] area is efficiently filled with wire.

Further, and similar to the conventional rotor design noted above, the winding end portions [68] outside the slots [64] contribute to energy loss while contributing nothing to the power output. Sometimes, there is as much wire in the winding end portions [68] as there is within the slots [64]. Thus, as a result of the conventional stator configuration, reasonably efficient design is compromised by the many “trade-offs.” Similar to design constraints present in conventional rotors, the stator's slots [64] required for the windings [62] also subtract from available laminations [58] area which reduces the flux, the voltage, and the power output of the generator.

Additionally, it is noted that CEPG stators are actually much more complex than the simplified drawing shown in FIGS. 2A and B. This is particularly true for three-phase generators with multiple slots per pole and with multiple windings that partially overlap each other. In some modern large CEPGs, the losses are so large that the designers have resorted to making the stator windings out of copper tubing with de-ionized water cooling.

### BRIEF SUMMARY OF THE PRESENT INVENTION

Structures of the present invention involve the use of steered flux and comprise uniquely simplified and efficient structures, including rotors free of windings or magnets, and stators with coils surrounding, not individual stator poles, but multiple poles or the rotor itself. In some embodiments, the present invention uses unipolar steered flux.

Rotors according to the present invention may comprise teeth or magnetic shorting bars that may, or may not, include separated and off-set separated concentric rings of teeth or magnetic shorting bars formed about a common shaft. The rotor merely switches, or steers, flux from one place to another rather than being the source of a rotating magnetic field. Accordingly, the rotor in each preferred embodiment is passive and contains no magnets or wire.

Stators according to the present invention comprise one or more highly efficient coils located external to the rotor. In several embodiments, the coils located external to the rotor are wound, not around individual stator poles, as in CEPGs, but concentrically about the rotor. An air-gap separates the stator and coils of the present invention from the rotor. Several embodiments of the present invention are “inverted” in that the stator and coil configuration provides a magnetic circuit that is wound around the coil rather than the conventional way of winding the wire coil around the magnetic circuit. The coils of the present invention are more consolidated, robust, efficient, and easier to install, maintain, and repair than are conventional stator coils. Furthermore, the present invention has many fewer coils.

Structures according to the present invention may involve a Magneto Motive Force (MMF) that is generated by self-bias or by external-bias. The MMF can be provided in four or more ways-none of which need be on the rotor: (1) permanent magnet(s) external to the stator (expensive, limited MMF); (2) resistive electromagnet(s) external to the stator (simple but bulky); (3) super-conducting magnet(s) external to the stator (most efficient, most expensive initially); and (4) self-bias where the magnetizing current is superimposed on the stator windings (simplest but less efficient).

The innovative self-bias MMF option (4) noted above uses a DC bias current superimposed on the stator windings to produce a bias field MMF which produces a flux which is switched by the variable reluctance of, for example, aligned and unaligned teeth on the rotor and stator. This novel approach utilizes two outputs whose AC voltages are out of phase to cancel the AC voltage thus allowing the DC bias to function.

In some embodiments using external bias, the present invention also overcomes limitations on the maximum MMF achievable since large external magnets (either resistive or super-conducting) can be used.

Selection of either self-bias or external-bias embodiments of the present invention is informed by several considerations including: compactness; simplicity; sharing MMF source by multiple electrical power generators; mechanical rigidity; contained fields; reliability; power output; efficiency; cost; etc.

Compactness favors use of a self-bias MMF electrical power generator since it does not require a large external magnet and this factor may provide a huge advantage for wind turbines. The self-bias generator also will be sturdier since its outer shell is one continuous magnetic piece whereas the external-bias generator needs to separate the two halves with a non-magnetic insert. Also, the self-bias generator contains the magnetic fields totally within the body of the generator whereas the external-bias generator has large external fields. Also, the installed cost probably favors the self-biased generator.

For embodiments comprising super-conducting magnets, the magnets and related support equipment are expected to be very expensive but that expense would be quickly recouped through better efficiency.

The external-bias generator is expected to be the most efficient if it satisfies the following four criteria. First, if it uses a resistive electromagnet, the electromagnet can be made as large as desired. The larger it is, the less loss it has because larger wire can be used. Second, if it uses a super-conducting magnet, the only loss will be the power required for the refrigeration equipment. It has been noted that super-conducting magnets may require only one percent of the electrical power that resistive magnets need. Third, for a three-phase generator, the self-bias generator has to create the MMF three times whereas the external-bias generator (whether resistive or super-conducting) only has to create the MMF once. Superimposing the bias on the stator windings results in, by far, the largest copper loss-much larger than the loss caused by the load current. Fourth, the self-bias generator may have to be made physically larger in order to allow larger stator windings. This means the magnetic paths will also be larger with resultant larger magnetic losses (eddy currents and hysteresis).

Importantly, however, since the self-bias generator superimposes the DC bias current on the stator windings, they will have several times the amount of power loss relative to the stator windings of the external-bias generator. Thus, they will run hotter. Heat, in turn, degrades wire insulation which is the most common cause of generator failure. Also, the power output of the self-bias generator will probably be limited by the heating that the stator windings can withstand; meanwhile, the external-bias generator can have more output.

By contrast, an external-bias magnet (whether resistive or super-conducting) can be shared among two or more generators. When an external-bias electromagnet is shared, and although the total flux required increases proportionally to the number of generators, the power required to produce the MMF only goes up as the square-root of the number of generators. This is because, for a fixed MMF, the total flux produced is proportional to the cross-sectional area of the magnet. Therefore, the efficiency goes up as more generators share the same magnet. The external-bias MMF generator is also much easier to visualize and understand, although its construction is very similar to the self-bias MMF generator. Also, the external-bias generator will be more cost effective over the life of the installation since it will be more efficient and deliver more billable electrical power.

Super-conducting magnets such as those used on the Large Hadron Collider in Zurich are used because they can produce extremely high flux density (up to 30+Tesla). Therefore, they use “low-temperature” (4 degrees above absolute zero) superconductors that have to be cooled by expensive liquid helium. In contrast, external-bias super-conducting magnets in the present invention only need a modest flux density (1-2 Tesla). Any more than that will saturate the iron conducting the flux. Therefore, they can use “high-temperature” superconductors cooled by inexpensive liquid nitrogen.

The reliability of the external-bias magnet, however, if shared may affect multiple generators. It is also noted that the external-bias magnet can be made with soft iron rather than laminations, since the flux is constant. It also can be wired with aluminum wire rather than very expensive copper wire since there are no space restrictions with external-bias, unlike the self-bias generator.

While each of self-bias or external-bias embodiments of the present invention has its own advantages and disadvantages, the self-bias generator may be preferable for, for example, wind turbines or automobile alternators, whereas the external-bias generator may be preferable for large fixed installations, such as water turbines.

The present invention overcomes many disadvantages associated with CEPGs by virtue of novel configurations that can eliminate the rotor field windings and magnets and greatly simplify stator coils. Structures of the present invention may have any number of poles and reduce the amount of winding materials used and space wasted by conventional rotor field windings and stator pole windings. Due to its improved design, structures of the present invention result in reduced heat and other energy losses, improved reliability, simplicity, ease of shipping, reduced production costs, etc.

While a major source of CEPG failure is due to insulation failure, the present invention will be much more reliable since: (1) there is much less wire subject to failure; (2) there is much less heat to degrade insulation; (3) there is much better cooling available; (4) the windings are not jammed into narrow un-insulated slots between poles; (5) the windings can be more securely supported which reduces chaffing of insulation; and (6) there is more room for thicker insulation.

Additionally, the present invention is distinguished over CEPGs in that CEPGs can only produce limited voltage due to insulation and wiring difficulties. By contrast, the present invention is not subject to these limitations, so it is able to produce much higher voltages.

Advantageously, the present invention also eliminates the need for gear boxes and related ancillary equipment in large windmills, and other applications. Such gear boxes are expensive, complex, inefficient, noisy, bulky, unreliable, prone to catastrophic fires, waste power, and require frequent, very expensive maintenance using, for example, 200-foot cranes. Further still, some embodiments of the present invention can eliminate the need for wasteful and costly external step-up transformers.

### BRIEF DESCRIPTION OF THE DRAWINGS

The accompanying FIGURES, which are incorporated in and constitute a part of this specification, illustrate various exemplary embodiments.

FIGS. 1A & 1B Prior Art Rotor, Top View (A) And Front View (B)

FIGS. 2A & B Prior Art Stator, Top View (A) And Front View (B)

FIG. 3 Prior Art Principle Of Operation

FIG. 4 Present Invention Principle Of Operation

FIG. 5 Principle Of Operation Experiment

FIG. 6 Variable Reluctance Principle Of Operation I

FIG. 7 Variable Reluctance Principle Of Operation II

FIG. 8 Switched Flux Principle Of Operation I

FIG. 9 Switched Flux Principle Of Operation II

FIG. 10 Axial Rotor And Stator Teeth Aligned

FIG. 11 Axial Rotor And Stator Teeth Unaligned

FIG. 12 Radial Rotor And Stator Teeth Aligned

FIG. 13 Radial Rotor And Stator Teeth Unaligned

FIG. 14 Two Outputs 180 Degrees Out Of Phase With DC Offset

FIG. 15 Output Cancellation With DC Offset

FIG. 16 Output Cancellation With No DC Offset

FIG. 17 Output Cancellation With No AC Current In The Bias Supply

FIG. 18 Three-Phase Output Cancellation

FIG. 19 Output Cancellation With Transformer Bias

FIG. 20 Output Voltage With Transformer Bias

FIG. 21 Efficient Generator With Permanent Magnet

FIG. 22 Simple Generator With Permanent Magnet

FIG. 23 Present Invention Stator

FIG. 24 Present Invention Rotor

FIG. 25 Present Invention Generator

FIG. 26 C-Cores Formed By Cutting

FIG. 27 Single Phase Generator Using Switched Flux

FIG. 28 Single Phase Generator Using External Bias

FIG. 29 Single Phase Generator Using Self-Bias

FIG. 30 Single Phase Generator Using Self-Bias

FIG. 31 Single Phase Generator Using Switched Flux

FIG. 32 Three-Phase Generator Using External Bias

FIG. 33 Another Three-Phase Generator Using External Bias

FIG. 34 Three-Phase Vector Diagram

FIG. 35 Three-Phase Generator Using Self-Bias

FIG. 36 Graph Of Efficiency Versus Output Power

FIG. 37 Graph Of Inefficiency Versus Output Power

FIG. 38 Prior Art Core Losses

FIG. 39 Present Invention Core Losses

FIG. 40 Graph Of Flux Coupling Versus Air-Gap

FIG. 41 Graph Of Power Output Versus Air-Gap

FIG. 42 Oscilloscope Picture Of Output Voltage

FIG. 43 Graph Of Output Voltage Versus Bias Current

FIG. 44 Open Circuit Output Voltage

FIG. 45 Maximum Open Circuit Voltage

FIG. 46 Short Circuit Output Current

FIG. 47 Maximum Short Circuit Current

FIG. 48 Graph Of Short-Circuit Current Versus Ibias

FIG. 49 Output Loaded

FIG. 50 Graph Of Maximum Power Versus Ibias

FIG. 51 Typical High-Voltage Transformer

### PRINCIPLES OF OPERATION OF THE INVENTION

The present invention does not depend on a rotating magnetic field as with CEPGs. Instead it operates with high permeability laminations operating only in quadrant “I” (see FIG. 4). As mentioned above, the rotor in the present invention merely switches, or steers, flux from one place to another rather than being the source of a rotating magnetic field.

The present invention can operate in either the variable reluctance mode or the switched flux mode.

In either mode (see FIG. 4), as the rotor turns in the presence of a bias magnetic field H_{bias}, it first couples strongly to the stator laminations because the rotor teeth are aligned with the stator teeth, then on the next half cycle the rotor couples weakly to the stator laminations because the rotor teeth are not aligned with the stator teeth (this will be described in more detail below). This same principle applies to the coupling between aligned and unaligned magnetic shorting bars on the rotor and stator, respectively.

The strong coupling is shown as the low reluctance R₁; the weak coupling is shown as high reluctance R₂. This varying coupling combined with the bias H_{bias} results first in an initial large flux density B₁=H_{bias}/R₁ then in an initial smaller flux density B₂=H_{bias}/R₂. This changing flux density times the cross-sectional area of the laminations, causes a changing flux Δφ=φ₁−φ₂.

It is noted that although the flux is unipolar, it is the change in flux that produces the voltage (not the change in direction of the flux that produces the voltage) so operation only in quadrant “I” is not a problem. The same equation mentioned above for the CEPG describes the output voltage V_{ac}=N*Δφ/ΔT where N is the number of turns of wire, Δφ is the change in flux, and ΔT is the interval of time in which that occurs.

When operating in the switched flux mode (see FIG. 4), the flux will take the path of least reluctance. If offered two paths, the flux will divide according to the ratio of the inverse of the reluctances R₁ and R₂.

Reference to the following symbols and terms throughout this specification may refer to the following:

φ=Flux (Webers);

B=Flux density (Tesla);

A=Cross-sectional area (square meters);

R=Reluctance;

H=Magnetizing force (Amps/meter);

N=Number of turns of wire;

MM F=Magneto Motive Force (amp-turns);

l=Length of path (meters);

μᵣ=Relative permeability (slope of BH curve);

μₒ=Permeability of air (4π*10⁻⁷);

T=Time (seconds);

V=Voltage (volts); and

I=Current (amps).

Similarly, equations and basic laws relating to magnetic circuits include:

φ=B*A;

H=N*I/l;

MMF=N*I; or =φ*R;

V=N*Δφ/ΔT;

μ=μᵣ*μₒ;

B=μ*H;

The sum of all MMFs around a loop must be zero; and

The sum of all fluxes at a node must be zero.

Units referred to herein are MKS units.

1. Variable Reluctance

One way to visualize the variable reluctance principle of operation of the present invention is by using a simple electrical solenoid with a DC bias as shown in FIG. 5. The power supply [300] and the resistor R [404] provide a simple source of bias current [320]. When the solenoid plunger [450] is moved in and out by hand, it changes the reluctance in the magnetic circuit. This change in reluctance combined with the bias current [320] results in an output voltage [448] being generated that can be readily observed with a meter or an oscilloscope. This operation is identical to what was previously described in connection with FIG. 4. Another way to visualize the principle of operation of the present invention operating in the variable reluctance mode is by using a simple magnetic circuit as shown in FIG. 6. Assume that the magnetic switch (the aligned and un-aligned teeth of the rotor and stator to be described below) is in position [430] connecting to a low reluctance R1. A magnet [72] provides an MMF which when divided by the low circuit reluctance R1 causes an initial large flux [420], most of which becomes large flux [422]. This flux [422] passes through the output coil [90].

Then when the magnetic switch is in position [432] in FIG. 7, it connects to a high reluctance R2. Then the MMF provided by magnet [72] divided by the high reluctance R2 produces an initial small flux [420], most of which becomes small flux [422] passing through coil [90].

Thus, the flux [422] in FIG. 6 and in FIG. 7 changes from a large value to a small value which couples to coil [90] and produces an output voltage. Notice that the flux [420] is not constant.

2. Switched Flux

A way to visualize the principle of operation of the present invention operating in the switched flux mode is by using a simple magnetic circuit as shown in FIG. 8. Assume the magnetic switches (to be described below) are in positions [431] and [433] which connects flux [422] to a low reluctance R1 and flux [426] to a high reluctance R2. A magnet [72] provides an MMF which when divided by the low circuit reluctance R1 causes a large flux [420], most of which becomes flux [422]. This flux [422] passes through the output coil [90]. The very small flux [426] passes through coil [92].

Then when the magnetic switches are in the opposite positions [432] and [434] as in FIG. 9, the situation reverses. Flux [422] now becomes small and flux [426] becomes large.

Thus, the flux [422] in FIG. 8 and FIG. 9 changes from a large value to a small value which couples to coil [90] and produces and output voltage; simultaneously the flux [426] changes from a small value to a large value which couples to coil [92] and produces an equal but opposite voltage.

Although the principles of operation of the variable reluctance (FIGS. 6 and 7) and the switched flux (FIGS. 8 and 9) modes of operation appear similar, there is twice as much output with the switched flux mode. Furthermore, in the switched flux mode, the flux [420] through the magnet [72] is virtually constant which reduces losses and facilitates using a super-conducting magnet or electromagnet to provide the MMF. Also the small flux ([426] in FIG. 8 and [422] in FIG. 9) with the switched flux mode is less than the small flux ([422] in FIG. 7) in the variable reluctance mode, thus yielding a larger change in flux and consequently a larger output voltage and more power.

### Aligned and Unaligned Teeth

The variable reluctance or the flux-switching is accomplished in several ways. The rotor can have axially aligned teeth or shorting bars (such as shown in FIGS. 10, 11, 21, 22, 23, 24, and 25) or there can be radially aligned and unaligned stator teeth (as shown in FIGS. 12, 13, 27, 28, 29, 30, 31, 32, 33, and 35).

To see how axial teeth work, see FIG. 10. As the generator rotor [10] turns, the rotor “magnetic shorting bars” [52] align with the stator poles [50] and cause strong magnetic coupling (low reluctance R₁ in FIG. 4) through the small air-gap [70] between the rotor and the stator. The flux can be visualized as flowing across the air-gap, into the page, back across another air-gap then back out of the page.

Then as the rotor [10] turns further (see FIG. 11), the “shorting bars” [52] become unaligned with the stator poles [50] which results in a large air-gap [71] between the rotor [10] and the stator [40] with resultant poor magnetic coupling (high reluctance R₂ in FIG. 4). It is this change in reluctance combined with the bias field caused by I_{bias} (to be described below) that produces the output voltage in the winding.

To see how radial teeth work, see FIGS. 12 and 13. In these Figures depicting radially aligned teeth, there are no shorting bars. The rotor and the stator segments are made up of a stack of laminations. Each tooth on the rotor comprises a pole. Each stator segment which (in this case) has nine teeth is equivalent to nine poles of a CEPG. Therefore (see [90] in FIG. 28) only one coil is required to encompass the total flux from all nine teeth. FIGS. 12 and 13 are illustrations of the laminations used to construct the prototypes depicted in FIG. 28 and FIG. 29. In FIG. 12, the teeth [112] in stator segments [42] and [46], respectively, are aligned with the teeth on the rotor [10] so the flux can flow easily across the short air-gap from stator segment [42], through the rotor [10], and through another short air-gap [70] to stator segment [46]. The flux can be visualized as flowing across the page from the upper left to the lower right. However, the teeth [112] for the other stator segments [44] and [48], respectively, are unaligned with the rotor teeth so very little flux will flow from segment [44] to segment [48] because of the large air-gaps [71].

FIG. 13 is exactly the same situation except that the rotor [10] has advanced one half a tooth pitch. Now the teeth in stator segment [44] and stator segment [48] are aligned with the teeth on the rotor so the flux can flow easily across the short air-gap [70] from stator segment [44], through the rotor [10], through another short air-gap [70] to stator segment [48]. The flux can be visualized as flowing across the page from the upper right to the lower left. However, the teeth for stator segments [42] and [46], respectively, are unaligned with the rotor teeth so very little flux will flow across the large air-gaps [71] from segment [42] to segment [46].

While the prior art principle of operation as described in FIG. 1 produces a larger maximum flux change because it uses bipolar flux, the present invention as described in FIG. 4 achieves the same or greater output power but in a simpler, more efficient and safer way (see below).

### Generator MMF

It is commonly assumed that motors can be operated as generators and that generators can be operated as motors. However, this is not always the case because generators require a source of M MF whereas motors do not.

As shown in FIG. 4, the present invention uses a fixed bias H_{bias} rather than permanent magnets or field windings. Clearly, the bias could be provided by a permanent ring magnet with the present structure (see [72] FIG. 21 or [72] FIG. 22) but one of the goals of the present invention is to eliminate permanent magnets. So the bias of the present invention may be achieved by other means.

### Sources for MMF

In the present invention, there are several ways that the MMF necessary for the generator to function can be provided—none of which need be on the rotor (these will be demonstrated on the various topologies described in more detail below): (1) Permanent magnet(s) external to the stator (expensive, limited MMF); (2) Resistive electromagnet(s) external to the stator (simple and effective but bulky); (3) Super-conducting magnet(s) external to the stator (most efficient, expensive); and (4) Self-bias where the magnetizing current is superimposed on the stator windings (simplest, less expensive). Each of these modes for providing MMF is further described in connection with various embodiments of the present invention as described below.

1. Self-Bias

A novel self-bias configuration uses a DC bias current superimposed on the stator windings to produce a bias field MMF which produces a flux which is switched by the variable reluctance of aligned and unaligned teeth on the rotor and stator. This novel approach utilizes two outputs whose AC voltages are out of phase to cancel the AC voltage thus allowing the DC bias to function. By superimposing the DC current on the stator windings, the existing output windings can be used for multiple purposes without any additional windings needed for providing the MMF.

The output voltage has two components: (1) V_{DC}, the DC offset caused by the bias current times the DC resistance of the winding; and (2) V_{ac}, the AC output caused by the varying flux.

The present invention addresses the problem of how to produce the small required DC bias voltage in the presence of the large AC output voltage. For example, one solution is that the resistor [404] in FIG. 5 could be replaced by a large inductor that would have a high reactance to V_{ac} at the operating frequency. Unfortunately, such an inductor would probably be larger than the generator.

A more satisfactory solution is to have the generator consist of two coils [60] as shown in the stator drawing of FIG. 23 (to be more fully described below). These two coils produce voltages that are 180 degrees out of phase. That is, one section produces an AC voltage +V_{ac} and the other section produces an opposite AC voltage −V_{ac} (see FIG. 14). When these are put in series, the AC voltages cancel out.

This can be accomplished by having the “magnetic shorting bars” on the rotor or the teeth on the stators offset by half of a pole pitch. Thus one section has increasing Δφ which generates a positive going voltage while the other section has decreasing Δφ which generates a negative going voltage. However, they are both offset from ground by V_{DC} (see FIG. 14).

In reference to FIG. 15, if the two output windings [90] and [92] are put in series, the AC components of the currents will cancel to zero at the output [448] but the DC components will add, resulting in 2*V total. The dots in the drawing indicate instantaneous winding polarity. This bias voltage 2*V_{DC} can be provided by a DC power supply [300] which supplies the bias current I_{bias} [476]. The bias field (H_{bias} in FIG. 4) is derived from the equation MMF_{bias}=N*I_{bias} and H_{bias}=MMF_{bias}/R where N is the number of turns of wire and I_{bias} is the DC current that is superimposed on the output winding and R is the total reluctance of the circuit.

Again referring to FIG. 15, the AC currents [440] and [442] add at the output [448]. The difficulty with this configuration is that the output [448] is offset from ground by V_{DC} and the DC power supply [300] has to handle AC currents [440] and [442].

A preferred embodiment of the present invention has a bridge configuration utilizing two bias supplies (FIG. 16 items [300]) so that the DC component V_{DC} (which would interfere with the operation of a step-up transformer by saturating its core) can be eliminated. In both FIG. 15 and FIG. 16, the output AC currents [440] and [442] from each of the two sections of the generator, add at the output [448] to produce the total AC output current.

As shown in FIG. 17, to prevent the AC components of the output currents [440] and [442] from going through the DC bias power supply, the coil on each of the two sections of the generator, can be split into two parts and connected in a bridge configuration. The bias supply then only has to handle DC current and not the AC current. Coils [90] and [92] are 180 degrees out of phase with coils [96] and [94]. The bias [300] is connected between terminals B-D. The load is connected between the two output terminals A-C. There is no DC voltage between terminals A-C.

Any point can be grounded. For example, terminal B may be grounded. If so, then terminal D will be a few volts DC above ground and the output terminals A and C will swing around ground.

Alternately, the bias supply [300] could be two supplies (of half the voltage each) in series, with the common point grounded. That way there would not be any DC offset at all and the output terminals A-C could feed a step-up transformer with its center tap grounded.

FIG. 18 shows how this could be accomplished for a three-phase generator where the three-phase AC outputs are labeled [460], [462], and [464] respectively. The bias supply (2*V_{D}) [300] with the positive terminal on rail [510] and the negative terminal on rail [512] produces the DC bias current [330] that is essentially identical for all three phases. The AC voltage arriving at [460], [462], and [464] from rail [510] is equal to and opposite to the voltage arriving at [460], [462], and [464] from rail [512]—therefore they cancel and there is no AC voltage on the rails [510] and [512]. However, the AC currents (shown representatively as [440] and [442] for output [448]) add at their respective outputs. The sum of all AC currents in rail [510] add to zero; likewise, the sum of all AC currents in rail [512] add to zero. Thus there are no AC currents or AC voltages in the rails [510] or [512] nor in the DC supply [300]. FIG. 18 is equivalent to FIG. 17 if one of the phases is deleted.

In reference to FIG. 19 (shown for a single-phase generator), the bias supply could also be a transformer [350] providing a low-frequency alternating current bias [250]. In that case, there would be no need for two separate coils for generator sections [360] and [362] and no need for a bridge configuration in order to eliminate the DC components. The output [448] would be the usual high-frequency alternating voltage but it would be modulated by the low-frequency bias voltage (see FIG. 20). The center tap of the bias transformer (item [350] in FIG. 19) is the ideal place to ground since the two AC output currents [440] and [442] cancel at the transformer. A logical bias voltage frequency may be 50 or 60 Hz so that the envelope of the resultant output voltage FIG. 20 could be demodulated to provide 50 or 60 Hz power.

### Efficiency

Efficiency is a critical design goal of the present invention. CEPGs have attempted to accomplish higher efficiency by using super-conducting wire for the DC field windings on the rotor. Unfortunately, this requires liquid helium to be pumped through the windings in order to keep them super-conducting. However, keeping a spinning rotor at super-conducting temperatures (about 4° above absolute zero) while surrounded by hot stators is an almost insurmountable engineering problem. This is particularly true if the generator is 200 feet off the ground in a wind turbine.

However, in the present invention, a novel structure will be shown below that allows utilizing super-conducting magnets on or external to the fixed stator in order to provide the MMF required. Because, once magnetized, super-conducting magnets have zero loss (except for the power required for the refrigeration equipment), using them can greatly reduce the overall loss, since the loss in the electromagnets producing the needed MMF is the largest copper loss in the generator. Such super-conducting magnets are not feasible with CEPGs.

As described above, the rotor in the present invention does not have a magnetized rotor as do CEPGs. Therefore it is constructed from simple passive laminations with no magnets, no wire, no slip rings, and no brushes. As a result, the rotor's only loss is magnetic hysteresis. Furthermore, it may have any number of poles for no extra cost.

The stator efficiency in the present invention is much higher than CEPGs since there are so many fewer windings and they can be wound with much larger wire due to the increased space available.

Windage losses are also lower for the present invention because of its larger air-gap. CEPGs are forced to use a small air-gap (as low as 0.060″ in large generators) in order to get sufficient H_{bias} with their limited MMF which is constrained by heating.

Another large source of inefficiency in CEPGs is the gear box such as those used in large windmills. A significant portion of the shaft power ends up as heat which requires complicated cooling and further loss of power to remove the heat.

### Various Embodiments

As pointed out earlier, the use of unipolar flux and the variable reluctance or switched flux modes of the present invention, allows for a variety of advantageous topologies and configurations not available with CEPGs. For example, rather than wrapping the wire around the laminations as is done in the CEPGs, some embodiments of the present invention wrap the laminations around the wire, while at the same time improving the wire fill factor, in order to achieve the desired coupling between the changing magnetic field and the wire. Additional embodiments are described below.

1. Efficient Generator with Permanent Magnet

As mentioned above, the stator (see FIG. 21) could include a permanent ring-shaped magnet [72] thus avoiding the need for bias current. This neat and efficient configuration involves two coils [60], offset rotor shorting bars (teeth) [22] and [24], stator [40], rotor [10], and shaft [32], and could be advantageous for small generators. It fully utilizes the strength of the permanent magnet [72] since its flux is not pulsating but is switched from one leg of the laminations to the other. Therefore smaller, less costly permanent magnets can be used.

2. Simple Generator with Permanent Magnet

FIG. 22 shows an uncomplicated structure using a non-centered ring permanent magnet [72] but it does not utilize the magnet to full advantage. FIG. 22 also shows stator [40], coil [60], rotor [10], and shaft [32]. The structures of FIG. 21 and FIG. 22 can be readily fabricated using sintered powder metallurgy or even insert molding.

3. Single Phase Self-Biased

The structure of one embodiment of the present invention (FIGS. 23, 24, and 25) is neat and efficient. The magnetic circuit of the stator [40](FIG. 23) consists of groups of laminations [50] that interact with corresponding laminations on the rotor (FIG. 24). FIG. 23 depicts the stator component from the top and from the front. Each group of laminations [50] constitutes a pole. Therefore, as many poles as desired can be easily produced, which can be very advantageous over conventional stators where the number of poles is severely limited because wire has to be wound around each individual pole. The structure of the present invention allows optimizing design parameters independent of “trade-offs” associated with conventional stators.

As shown in FIG. 23, the coils [60] are simple spools of wire that achieve almost 100% fill-factor, which enhances its efficient contribution to the output power. As a result, for example, copper losses are minimized. Also, there are no end windings as in CEPGs to cause energy loss. Thus, the coil shape is optimized. Also, advantageously, the coil does not bend around any sharp edges of the laminations as in CEPGs that could cause insulation failure. Cooling of the coil [60] is also excellent because there is a direct path for the heat to the outside of the stator via the laminations, potting material, etc. Component [30] is a non-magnetic potting material commonly used to insulate transformers and motors. It has the further benefit of reducing vibration, improving heat transfer and reducing windage loss (aerodynamic drag). The coil [60] can also be formed from strips of sheet metal (such as copper) wound helically like a roll of Scotch™ tape. An advantage of such a structure is that the voltage between layers is only V_{ac}/N so the insulation does not get stressed and could be as simple as anodizing an aluminum strip.

The corresponding rotor [10] is also neat and efficient (see FIG. 24). In several embodiments, it consists of magnetically conducting laminations acting as “shorting bars” [22] and [24] arranged around the circumference of the rotor and which may be offset to generate opposite voltages in the two stator coils. These correspond to, or match up with, the poles [50](not shown) on the stator. In one exceptional embodiment, however, the rotor [10] is simply one solid piece of 3% silicon steel (“transformer steel”) machined to produce the bars [22] and [24] and may comprise a solid metal rotor without any potting material [30]. However, for large installations, the “magnetic shorting bars” may consist of assemblies of laminations to reduce “core loss” due to circulating currents in the laminations. For reasons explained below, the upper “shorting-bars” [22] are offset from the lower “shorting-bars” [24] by half of a pole pitch. Item [32] is the shaft that provides the mechanical drive power for the rotor. Item [30] is non-magnetic potting material such as RTV, epoxy, or resin.

To someone familiar with the conventional method of wrapping the wire around the laminations, it may not seem that the windings of FIG. 23 enclose the changing flux. However, by studying the structure of FIG. 25 which is a composite of FIG. 23 and FIG. 24, it will become evident that the coils [60] do enclose the changing flux [200] in the magnetic circuit.

In each preferred embodiment of the present invention, there are no windings, no magnets, no slip rings, and no brushes on the rotor as in CEPG rotors. Because there are no windings, slip rings, and brushes, there is virtually no loss in the rotor (only core loss), very little aerodynamic drag (it can be made smooth), and a more secure construction is achieved. The rotor can be spun as fast as desired and it will not throw windings or magnets at extreme speeds because there are no windings or magnets to throw.

The lack of windings and the rugged and secure design structure make the present invention ideally suitable for many applications. The present invention may be particularly well-suited for use with windmills, where excess speed due to high winds cause CEPGs to throw windings due to centrifugal force with resultant destruction of the equipment or other dangerous results. Another particularly useful application for the present invention may be automobile alternators.

Some of the drawings of the present invention (for example, FIG. 25) show it as if it were made from E-core laminations. This construction has some advantages since the flux through the center leg of the E-core is constant and is merely switched between the upper leg and the lower leg as the rotor turns. This means the center leg will have no core loss since it has no flux change.

On the other hand, there are advantages with using C-core laminations and stacking two such assemblies to accomplish the same thing as using E-cores. For huge installations, it would be easier to transport and assemble on site. Yet another advantage is that it would be more rugged. Furthermore, three pairs could be stacked to give three-phase output.

Alternatively, an uncomplicated and very effective way to make C-core laminations for use with the present invention is shown in FIG. 26. The lamination material [98] in strip form is wound on a mandrel [100] to form an oval. It can be bonded as it is wound by adding some adhesive [102]. After the adhesive is cured, the part is cut in half to make two C-cores [82] which can then be assembled into the stator. This would be ideal for material such as Metglas® which loses its outstanding magnet properties if it is bent sharply.

4. Generator Using Switched Flux

Another embodiment illustrating the practical application of these same concepts is shown in FIG. 27. This is an unusual embodiment in that it produces bipolar flux in the coils [90] and [92] although there is unipolar flux across the air-gaps. Electromagnets [72] bias the upper half of the generator as a North magnetic pole [220] and the lower half of the generator as a South magnetic pole [230]. This is the source of MMF for the generator. Because of this bias, flux will attempt to flow from electromagnets [72], through one of the upper stator segments [42] or [44], through the rotor [10], through one of the lower stator segments [46] or [48] and back to electro-magnets [72]. For example, if the rotor teeth are aligned with the teeth in stator segments [44] and [48], then that will be a low reluctance path and the flux will take that path from stator segment [44] to stator segment [48]. This is shown as flux paths [204].

Half a cycle later, the rotor teeth will align with the teeth in stator segments [42] and [46] and so the flux will take a path from stator segment [42] to stator segment [46]. This is shown as flux paths [202].

The rotor [10] which spins on shaft [32] is completely passive and merely acts as a magnetic switch to steer the flux from one path to the other. It has no loss other than magnetic hysteresis.

The sum of the flux through each of the electromagnets is approximately constant. Because of that fact and because the electromagnets are located on the fixed stator rather than on a spinning rotor, these could readily be replaced by super-conducting magnets if desired as shown later in FIGS. 28, 32, and 33. As mentioned previously, such magnets have zero loss except for the power required for the refrigeration equipment. This equipment would be stationary and not mounted on a spinning rotor.

Either one of the electromagnets [72] in FIG. 27 may be deleted as shown in FIGS. 28, 32, and 33 (with resultant power savings) if desired without affecting the functioning of the generator. The remaining electromagnet will need the same MMF but will need double the cross-sectional area of the core to provide the total flux. This will have only minor impact on the remaining structural configuration since the windings tend to be long rectangles so doubling the short side has very little effect on the wire length. Furthermore, the electromagnet can be external to the stator.

There is no need for slip rings and brushes since the rotor is completely passive and there is no refrigeration equipment on the rotor requiring power. This eliminates the problems of brush reliability, maintenance, cost, RFI, and inductive voltage spikes.

The varying flux through the stator segments is unipolar and operates in sector I of the magnetic BH loop (see FIG. 4).

The varying unipolar flux passes through output coils [90] and [92] first one way then the other way producing a varying bipolar flux which generates the output voltages. One coil generates the in-phase output; the other coil produces the out-of-phase output.

5. Single-Phase Generator Using External-Bias

FIG. 28 shows one of the prototypes actually built and tested, verifying the concept of external-bias. Its unusual shape was so it could be easily modified. FIG. 28 is an example of a single-phase generator using external-bias. The external electromagnet [72] is formed by coil [88] wound around a soft iron side rail [514] to create the necessary MMF making the top rail [510] for example a North magnetic pole [220] and making the bottom rail [512] for example a South magnetic pole [230].

This causes a fairly constant flux [200] to flow which is steered from one path to another by the rotor [10]. Since the flux is essentially constant, it is satisfactory to make the side rail [514] out of solid soft iron without worrying about hysteresis losses. Furthermore, the electromagnet [72] could be replaced by a super-conducting magnet.

The other side rail [340] is made of non-magnetic aluminum and is there just for mechanical support.

The top rail [510], the bottom rail [512] and the stator segments [42], [44], [46], and [48] are all made out of steel laminations since they have varying flux.

The stator segments [42], [44], [46], and [48] are arranged so that the teeth on segments [42] and [46] align with the teeth on the rotor [10] when the teeth on segments [44] and [48] do not align with the teeth on the rotor [10]. Likewise, the teeth on segments [44] and [48] align with the teeth on the rotor [10] when the teeth on segments [42] and [46] do not align with the teeth on the rotor [10]. Therefore as the rotor [10] turns, there are two alternate preferred paths for the flux to flow: path [202] and path [204].

As the alternating fluxes [202] and [204] pass through their respective coils (for example [90]), they generate voltages in each coil that produce output power. The outputs of the four coils can be placed in parallel (for more current) or in series (for more voltage) or a combination of the two.

6. Single-Phase Generator Using Self-Bias

Another embodiment that was also built and tested, verifying the concept of self-bias, is shown in FIG. 29. This is a single-phase self-bias generator. Although it looks very similar to FIG. 28, it does not have an electromagnet and both side rails [514] are made out of soft iron. As mentioned above, one of them could be deleted and replaced by an aluminum rail for mechanical support.

Similar to FIG. 28, the top rail [510] in FIG. 29, the bottom rail [512] and the stator segments [42], [44], [46], and [48] are all made out of transformer steel laminations since they have varying flux.

Also similar to FIG. 28, the stator segments [42], [44], [46], and [48] in FIG. 29 are arranged so that the teeth on segments [42] and [46] align with the teeth on the rotor [10] when the teeth on segments [44] and [48] do not align with the teeth on the rotor [10]. Likewise, the teeth on segments [44] and [48] align with the teeth on the rotor [10] when the teeth on segments [42] and [46] do not align with the teeth on the rotor [10]. Therefore as the rotor [10] turns, there are two alternate preferred paths for the flux to flow: path [202] and path [204].

The top rail [510], the bottom rail [512], and the two side rails [514] are essentially magnetically neutral-neither a North magnetic pole nor a South magnetic pole. However, because of the DC current superimposed on the stator windings (see explanation of self-bias above), the stator segments are magnetized so that the teeth of stator segments [42] and [44] are, for example, North magnetic poles and the teeth of stator segments [46] and [48] are, for example, South magnetic poles.

Therefore, when the teeth of segments [42] and [46] line up with the rotor teeth, flux path [202] will be strong and flux path [204] will be weak. Likewise, when the teeth of segments [44] and [48] line up with the rotor teeth, flux path [204] will be strong and flux path [202] will be weak.

As the alternating fluxes [202] and [204] pass through their respective coils (for example [90]), they generate voltages in each coil that produce output power. The coils for segments [42] and [46] are wired in series so their AC voltages cancel at the bias supply. Likewise the coils for segments [44] and [48] are wired in series so their AC voltages cancel at the bias supply. The common point of the coils for segments [42] and [46] produce a positive Vac while the common point of the coils for segments [44] and [48] produce a negative Vac.

7. Another Single-Phase Generator Using Self-Bias

Another embodiment that works on the same principles is shown in FIG. 30.

It has four identical output coils [90], [92], [94], and [96]. Voltage sources [300] produce a bias current [330] that splits, with half going through coils [90] and [96] and the other half going through coils [92] and [94]. These currents cause the pole tips for stator segments [42] and [44] to be biased as South magnetic poles and for the pole tips for stator segments [46] and [48] to be biased as North magnetic poles. Thus, flux tends to flow through stator segments [46] or [48], through the rotor [10], and through stator segments [42] or [44]. If the rotor teeth align with the teeth in stator segments [42] and [46], then the flux will take path [202]. Half a cycle later when the rotor teeth align with the teeth in stator segments [44] and [48], then the flux will take the other path.

Since stator segment [48] will be increasing in flux while stator segment [42] is decreasing, the voltages from coils [90] and [96] will be the opposite polarity to cancel and produce the in-phase output [260]. Conversely, stator segment [44] will be increasing in flux while stator segment [46] is decreasing, so the voltages from coils [92] and [94] will be the opposite polarity to cancel but opposite to the in-phase output [260] in order to produce the out-of-phase output [270].

As mentioned earlier, the AC voltages and AC currents cancel out so the bias voltage sources [300] only have to deal with DC voltages and DC currents.

Similarly, the DC voltages cancel out so there is no DC potential between the in-phase output [260] and the out-of-phase output [270] which might affect a step-up transformer.

8. Yet Another Single-Phase Generator Using Self-Bias

FIG. 31 is essentially the same as FIG. 30 except the coils are wound around the back iron rather than around each stator segment. Please refer to the discussion of FIG. 30, above, with respect to the various reference identifiers provided in FIG. 31.

9. Three-Phase Generator with External-Bias

FIG. 32 is an embodiment of a three-phase generator with external-bias which can be an electromagnet [72] or a super-conducting magnet [72]. In addition, this magnet [72] can be shared with an adjacent generator if desired.

Stator segments [42], [44], and [46] are biased as, for example, North magnetic poles [220] while stator segments [48], [106], and [108] are biased as, for example, South magnet poles [230].

The teeth on the stator segments are offset from the teeth on adjacent stator segments relative to the rotor teeth. For example, when stator segments [42] and [48] are aligned with the rotor teeth, the teeth on segments [44] and [106] are offset by 120 electrical degrees (one-third of a tooth pitch) whereas the teeth on segments [46] and [108] are offset by 240 electrical degrees (two-thirds of a tooth pitch).

Therefore as rotor [10] turns, there are three sequential preferred flux paths—from [42] to [48]; from [44] to [106]; or from [46] to [108].

As the alternating fluxes pass through their respective coils (shown representatively as [92]), they generate voltages in each coil to produce output power.

Similar to FIG. 28, the stator segments [42], [44], [46], [48], [106], and [108] in FIG. 32 are all made out of transformer steel laminations since they have varying flux. Similarly the rotor [10] is made out of laminations since it steers the flux. The two side pieces [340] are made of non-magnetic material (aluminum) and are there just for mechanical support.

10. Another Three-Phase Generator with External-Bias

Another novel three-phase external-biased generator is shown in FIG. 33. Stator segments [42], [44], and [46] are biased as, for example, North magnetic poles [220] while stator segments [48], [106], and [108] are biased as, for example, South magnet poles [230].

The teeth on the stator segments are offset from the teeth on adjacent stator segments relative to the rotor teeth. For example, when stator segments [42] and [48] are aligned with the rotor teeth, the teeth on segments [44] and [106] are offset by 120 electrical degrees (one-third of a tooth pitch) whereas the teeth on segments [46] and [108] are offset by 240 electrical degrees (two-thirds of a tooth pitch).

Therefore as rotor [10] turns, there are three sequential preferred flux paths—from [42] to [48]; from [44] to [106]; or from [46] to [108].

As the alternating fluxes pass through their respective coils [90], [92], [94], and [96], they generate voltages in each coil to produce output power.

This is a very unusual configuration in that only four coils are needed to produce three-phase Y-connected outputs. Using the vector diagram of FIG. 34, with reference to FIG. 33, coil [90] produces an output [601] while coil [94] produces an equal but opposite output [602]. Likewise, coil [92] produces an output [603] while coil [96] produces an equal but opposite output [604]. Phase A of the three-phase output is simply [601]; Phase B of the three-phase output is simply [603]; Phase C of the three-phase output is the sum of [602] and [604]—in other words [605], the outputs from coils [94] and [96], are put in series.

11. Three-Phase Generator with Self-Bias

FIG. 35 is another three-phase generator utilizing self-bias. It is very similar in appearance to FIG. 30 except it is three-phase rather than single-phase. The reference numbers identified in FIG. 35 are as indicated elsewhere in this disclosure.

### High Voltage

The present invention is able to produce higher voltages than CEPGs. This could be advantageous by eliminating expensive, loss producing step-up transformers. Compare the structure of conventional high-voltage transformers with the present invention. Conventional high voltage transformers are wound on a C-core made of silicon steel laminations such as shown as [701] in FIG. 51. The low-voltage primary [702] is wound first next to the core [701]. Then the many-turn high-voltage secondary [703] is wound over it layer by layer. Since the secondary voltage gets higher as it gets further from the core, insulating it from the primary and from the core becomes less difficult. Typically, the whole thing is immersed in oil which cools it and provides better insulation than air.

Comparing the high voltage transformer configuration FIG. 51 to the present invention (for example, see FIGS. 27 & 31), the coils on the present invention are similar in function to the high voltage [703] coils on the transformer except there are no primary coils [702](which takes up half the area in conventional high voltage transformers). That leaves even more room in the present invention for the high-voltage secondary. The alternating flux which would normally be provided by the current in the conventional high voltage transformer primary [702] is instead provided by the flux steering action in the present invention.

Since the present invention has a large area available for its coils, it has room for the wire and for the high-voltage insulation whereas a conventional generator is extremely constrained on area. Therefore, higher voltages can be produced by the present invention than with CEPGs.

Thus, the same design constraints and opportunities exist for high-voltage output from the present invention as for a high-voltage transformer without incurring the cost, power loss, space, maintenance, and reliability issues of having an external step-up transformer.

### Design Considerations

Output voltage is directly dependent on the number of poles in the generator. CEPGs are limited in the number of poles they can achieve due to the copper windings that must be wrapped around each pole. Some stepping motors (which are similar in appearance to generators) have achieved up to 24 poles but this is rare. Some extremely large generators (such as at Hoover Dam) have 40 pairs of poles in order to produce 60 Hz power when turned at 90 rpm by a water turbine. Obviously, this is a very complex and expensive structure. However, the present invention can achieve as many poles as desired, restricted only by machining and materials limitations, since the individual poles are not wrapped in wire but are produced by machining or stamping or by assembling lamination stacks. For example, one prototype generator built according to the present invention had 24 poles, but could easily have had 200 or more. Two other prototypes shown in FIGS. 28 and 29 have 40 poles.

For a given rotation speed (rpm), the output frequency and output power are directly proportional to the number of poles. If 60 Hz power is desired, the number of poles is fixed so that increasing the number of poles in order to make a smaller generator is not an option. However, if the generator is producing power to be converted to ultra-high voltage DC for interstate transmission (HVDC), for example, the ready ability to increase the number of poles could be a huge advantage because the output voltage goes up with increasing frequency. This is similar to the benefits achieved with switching power supplies that get smaller the higher their operating frequency. Likewise, if the generator with many poles (and thus higher frequency output) is used to drive a step-up transformer, rectifier and filter to produce HVDC, then smaller filter capacitors and smaller step-up transformers would be required. In one embodiment, a generator according to the present invention with 24 poles can operate at 400 Hz when rotated at 1,000 rpm.

### Comparing Windings in CEPGs and the Present Invention

One of the most dramatic differences between CPEGs and the present invention are the windings. For example, compare typical large 60 Hz generators driven at 90 rpm by water turbines. Such generators need 40 pairs of poles in order to product 60 Hz power (since 90 rpm=1.5 rev/second, therefore the number of pole pairs is 60 Hz divided by 1.5 rev/second=40 pole pairs).

Both types of generators need equivalent sources of MMF sufficient to produce enough flux to almost saturate the stator pole pieces. In CEPGs, the electromagnets are mounted on the rotor but in the present invention, the electromagnet can be mounted on or external to the stator or, if self-bias is used, the stator is the electromagnet.

Thus, a traditional generator has 40 pairs of rotor poles with each one wound with enough turns to create the needed MMF. Likewise, the present invention needs to produce the same MMF but it only has to do so once, not 40 times. The pairs of coils in both cases are almost the same wire size, turns, length, and amperage but in the present invention there are only 1/40th as many coils and therefore only 1/40th as much copper and 1/40th as much power loss.

Furthermore, since CEPGs have their coils on the rotor, there is very restricted space and very limited cooling. On the other hand, the present invention has its electromagnet coil on or external to the stator with substantially larger space (thus less resistance and even less loss) and unrestricted cooling.

Since the copper losses in the electromagnet dominate the copper losses in the generator, the present invention will have a huge reduction in copper loss in producing the needed MMF. Although an external electromagnet is now quite practical for the present invention, even this much-reduced loss can be virtually eliminated by using super-conducting magnets. Such magnets are not feasible with CEPGs.

Comparing the stator windings, single-phase CEPGs have 40 pairs of stator coils. Each pair of poles has to have their own coils in order to encompass the flux from their individual poles. However, the present invention uses its stator laminations to concentrate its flux so only two pairs of stator coils are needed for single-phase outputs (and three pairs for three-phase outputs). So, just as in the case of the coils for the electromagnet, the stator coils are only 1/20th as large and yet there is a huge amount of room for them since they do not have to be jammed into the stator slots. Thus, the copper losses in the present invention stator windings are less than 1/20th that of single-phase CEPGs and less than 1/40th that of three-phase CEPGs.

Furthermore, the coils in the present invention are very simple and easily installed. In contrast, the twenty (or forty) times as many coils in a traditional generator are very complex (particularly for three-phase designs where there are 120 overlapping pairs) and are extremely labor-intensive to install.

### Scaling

The present invention can achieve extreme efficiency as the design is scaled. As the size of the generator is increased, the efficiency increases rapidly. This can be understood by considering what happens when all three dimensions of the generator are scaled or increased in size simultaneously.

For example, with respect to losses due to bias and output current, the cross-sectional area of the copper windings goes up as the square of the scaling. However, the resistance of the wire R_{DC} only goes down linearly with scaling because the length of the wire increases linearly with scaling. Since the air-gap increases with scaling, the required bias I_{bias} goes up linearly in order to keep the same Bₘₐₓ. Similarly (as will be shown below) the output current I_{ac} goes up with I_{bias}. Therefore the loss Pₗₒₛₛ=R_{DC}*I² goes up linearly with scaling; meanwhile, contributions to output power generation go up at an even faster rate.

Also, with respect to output power, the change in flux Δφ goes up as the square of the scaling since the cross-sectional area of the laminations goes up as the square of the scaling. Therefore the output voltage V_{ac} goes up as the square of the scaling. As mentioned above, the output current I_{ac} also goes up linearly with scaling. Therefore, the output power Pₒᵤₜ=V_{ac}*I_{ac} goes up as the cube of the scaling.

Further, with respect to efficiency, since the power loss Pₗₒₛₛ goes up linearly with scaling (see above) and the output power Pₒᵤₜ goes up as the cube of the scaling (see above), then efficiency E=Pₗₒₛₛ/Pₒᵤₜ improves as the square of the scaling.

This can be readily seen from FIG. 36 which shows generator efficiency as a function of output power. For very large installations, the efficiency can become extremely good.

Another way to visualize the same data is FIG. 37 which shows inefficiency U=(1−E) as a function of generator output power. Although the total power loss actually goes up with scaling, the inefficiency goes down and (except for core loss) approaches zero for extremely large designs.

Cooling becomes easier with scaling because even though the power loss goes up linearly with scaling, the surface area of the generator goes up as the square of scaling so there is much more area to provide cooling. This improves reliability and service life of the equipment.

Additionally, the overall efficiency is also affected by core loss. This occurs due to hysteresis and eddy currents in magnetic material, such as 3% silicon steel laminations. For simplicity, the BH loops shown in FIGS. 1, 4, 44, 45, 46, and 47 are shown as straight lines. However, they are actually loops as shown in FIGS. 38 and 39. The loops are caused by the energy required to reverse the individual magnetic domains within the laminations. The area enclosed by the loops is proportional to the energy required. This lost energy shows up as heat in a generator.

In CEPGs, the flux changes from +Bₘₐₓ to −Bₘₐₓ and encloses a large area [1] on the BH major loop (see FIG. 38). However, in the present invention, the laminations operate on a BH minor loop and enclose a much smaller area (see [1] FIG. 39). Therefore, operation of the laminations on a minor loop in the present invention results in greatly reduced hysteresis losses.

Using commercial data supplied by Protolam Magnetic Materials, Inc., core loss per pound for the particular material used in the prototypes can be calculated as P_{LB}=2.26E-11*(Freq̂1.532)*(B̂1.904) where Frequency is in Hertz and B is in gauss. Therefore, core loss per pound of material goes up as the 1.5 power of frequency. As a result, the maximum frequency may be limited by acceptable efficiency.

Generator magnetic losses are due to two phenomena: Hysteresis loss and eddy current loss. As mentioned above, data published by lamination companies lump both losses together. They have charts of loss per pound versus frequency, flux density, thickness of material and type of material. By digitizing these charts and curve fitting equations to each chart, the inventor has theorized and derived an equation that expresses loss in watts per cubic-meter when frequency is expressed in Hertz and flux density is expressed in Tesla: P=5.63*(Freq̂1.532)*(B1̂1.904−B2̂0.904).

CEPG generators have bipolar flux and saturate the material in both directions. In that case B2=−B1 which results in a large flux density change of B2+B1 and therefore there is lots of loss. This can be seen in FIG. 38. The large enclosed area as [1] represents the loss for a traditional generator. In contrast, the switched flux generator of the present invention uses unipolar flux operating on a minor loop. In that case, B2 is the same sign as B1 for a small flux density change of B2−B1 and the loss is substantially reduced. This can be seen in FIG. 39. The small enclosed area identified as [1] in FIG. 39 represents the loss for the present invention generator.

The inventor, using actual numbers from computer simulations and the equation noted above, found that B1=1.329 Tesla and B2=1.142 Tesla. Therefore, it is believed that the ratio of loss for traditional generators to switched flux generators could be as high as 7.104. In other words, because of operating on a small minor loop, and based on the above equation, it is expected that structures of the present invention can achieve up to a seven-fold reduction in core loss for each kilogram of material.

A computer program such as ANSYS™ multi-physics can be used to accurately predict the flux coupling between aligned teeth (see FIG. 10) and between unaligned teeth (see FIG. 11) as the air-gap is changed (see also FIGS. 12 & 13). The somewhat less-accurate results using a much less expensive computer program, VisiMag, are shown in FIG. 40. The flux coupling drops off rapidly with increasing air-gap as expected. However, if the bias current I_{bias} is increased accordingly so that the maximum saturation flux Bₘₐₓ remains the same, the power output continues to increase as the air-gap is increased. Unfortunately, as the air-gap increases, a point is reached when the change between the aligned flux and the unaligned flux drops off and therefore the voltage likewise decreases.

The power output Pₒᵤₜ is equal to the load current I_{ac} (which is proportional to and less than the bias current I_{bias}) times the output voltage V_{ac} (which is proportional to the change in the flux between aligned and unaligned teeth). This is shown as FIG. 41 which plots Output Power versus Air-gap.

According to the inventor's calculations, there is an optimum air-gap to produce the maximum output power which is approximately 0.08 times the tooth pitch. CEPGs operate at an air-gap much smaller than this optimum gap because they are unable to produce sufficient MMF with an acceptable power loss with rotating electromagnets on the rotor. For example, a large CEPG with a pole pitch of 9 inches will have an air-gap of only 0.060″—way below what the inventor considers optimum which is around 0.72″ (0.08*9″).

Since the load current times the number of turns of wire produces an MMF that tends to buck the bias MMF, therefore making the air-gap larger (which requires larger bias MMF in order to maintain the same Bₘₐₓ) allows more load current. This is readily possible with the present invention, but CEPGs cannot produce larger bias MMFs because of limited space and cooling for the windings on the rotor. With the present invention's external-bias, there is far less limitation to the bias MMF (and thus, the load current) that can be produced. Since output power is the product of voltage (which is proportional to flux change) and current, even though the present invention's unipolar flux is smaller than CEPGs' bipolar flux, the power produced can equal or exceed the power produced by CEPGs.

Even though the maximum power obtainable continues to increase gradually up to a maximum with increasing air-gap (FIG. 41), the copper losses go up dramatically as the square of the load current which is linearly affected by the air-gap. Scaling of the resistance or any other parameter is not involved here since only the air-gap is being changed for this discussion. Therefore, the maximum output power obtainable is limited by acceptable losses rather than by an optimum air-gap. For example, increasing the air-gap from 60 mils to 200 mils merely doubles the output power but the losses go up by (200/60)̂2=11.1 times the loss. However, bear in mind that the present invention has many fewer windings than CEPGs and these fewer windings can have much larger wire so they can handle larger load currents and still have lower losses than CEPGs.

An oscilloscope picture of the output voltage of a prototype is shown in FIG. 42. The magnitude of this voltage is dependent on the value of I_{bias} (remember that MMF_{bias}=N*I_{bias}). The open-circuit output voltage V_{ac} was measured for many values of I_{bias} for the prototype of FIG. 25 and the results are shown in FIG. 43. As I_{bias} is increased, V_{ac} increases until it reaches a peak. The peak occurs when the back iron of the E-laminations saturate at 0.8 amps. This includes the flux through the end leg plus the stray flux.

After the back iron saturates, additional bias current will produce no more flux. That is, the intersection of the aligned minimum reluctance load line (R₁ in FIG. 4) with the BH loop will move across the horizontal portion of the saturated BH loop at Bₘₐₓ resulting in no more flux. However, as I_{bias} increases still further, the intersection of the unaligned maximum reluctance load line (R₂ in FIG. 4) will continue to move up the BH loop. Thus, the change in flux will decrease, which will reduce the output voltage V_{ac}. If nothing else happened, the voltage would continue to decrease and go to zero when the unaligned maximum reluctance load line (R₂ in FIG. 4) intersected the BH loop at Bₘₐₓ. The slope of the curve down to the X-axis can be projected to approximate that condition.

However, before that happens, the other leg of the E-lamination saturates at 1.05 amps and no further flux is possible no matter how much the bias current is increased. At that point, the other leg of the E-lamination will be carrying Bₘₐₓ which equals the sum of the stray flux plus the flux produced by the intersection of the maximum reluctance load line R₂ with the BH loop.

Although the BH loop of FIG. 4 shows the basic principle of operation, it may not be well-suited for prediction of various output conditions. For a given geometry and a given number of turns of wire (for example, 500 turns of #20 copper wire), the vertical B (flux density) axis is also proportional to the total flux and also proportional to voltage. Likewise, the horizontal H axis is proportional to MMF and current. Therefore, the axes as shown in FIGS. 44, 45, 46, and 47 can be re-labeled, as described in further detail below.

FIG. 44 shows the open-circuit condition where there is no load current so I_{ac}=0. This Figure is similar to FIG. 4 except the optimum bias current I_{bias} is higher and the low-reluctance load-line R₁ intersects the flat portion of the BH loop. No more flux can be switched since the magnetic material is saturated at Bₘₐₓ. The change in reluctance causes an output voltage V_{oc}. This was shown previously as FIG. 43.

The open-circuit condition does not produce the maximum possible output voltage. That condition is shown in FIG. 45. FIG. 45 differs from FIG. 44 in that the bias current that causes the maximum output voltage Vₘₐₓ is lower than the optimum bias current I_{bias}. The maximum output voltage Vₘₐₓ occurs where the low-reluctance load-line R₁ intersects the BH loop at the knee Bₘₐₓ. Although this value of I_{bias} produces the maximum output voltage, it does not produce the maximum output power. That requires higher I_{bias} (as shown below). Since the output current I_{ac} is zero in the open-circuit condition, the output power Pₒᵤₜ=I_{ac}*V_{ac} is also zero.

FIG. 46 shows the short-circuit condition where there is no load voltage so V_{ac}=0. Since there is no AC output voltage, the flux cannot change and stays fixed. As a result, the short-circuit current I_{sc} opposes any flux change even though the optimum I_{bias} exists and the reluctances change. Notice that the short-circuit AC current is symmetrical around the bias current I_{bias} since there can be no DC component to it.

The short-circuit condition does not produce the maximum possible output current. That condition is shown in FIG. 47. FIG. 47 differs from FIG. 46 in that the bias current that causes the maximum output current Iₘₐₓ is higher than the optimum bias current I_{bias}. There is no peak to the maximum short-circuit current, i.e., it flattens out and continues to grow slightly (because the saturated Bₘₐₓ is not quite flat) as can be seen in FIG. 48 which is the actually measured short-circuit AC current in an embodiment of the present invention. The maximum useable current occurs where in FIG. 47 the load-line R₁ and the load-line R₂ both intersect the BH loop at the knee. This is where the magnetic material is saturated at Bₘₐₓ. Since the output voltage V_{ac} is zero in the short-circuit condition, the output power Pₒᵤₜ=I_{ac}*V_{ac} is also zero. Notice also that the AC current is always lower than I_{bias}.

Although each of the above conditions yields insight into the operation of the generator, they do not represent real loads. FIG. 49 shows the output condition when a real load is applied to the generator. It is a combination of the open-circuit and the short-circuit conditions. The load current I_{ac} opposes the flux change (similar to the short-circuit condition) but is not large enough to totally prevent the change. It tends to shift the load-line right or left (whichever opposes the change). Therefore the output voltage V_{ac} is somewhat less than the open-circuit voltage V_{oc} (see FIG. 44) and the load current I_{ac} is somewhat less than the short-circuit current I_{sc} (see FIG. 46).

The largest power output is achieved when Pₒᵤₜ=I_{ac}*V_{ac} is maximized. This can be visualized as the area in the rectangle (FIG. 49, blackened area). It occurs near where the shifted load-line R₁ intersects the BH loop at the knee. This is where the magnetic material is just in saturation at Bₘₐₓ. The optimum value of I_{bias} is approximately midway between the value of the bias (see FIG. 44) that creates the maximum open-circuit voltage Vₘₐₓ and the value of the bias (see FIG. 46) that creates the maximum short-circuit current Iₘₐₓ.

FIG. 50 shows maximum power measured on a prototype versus I_{bias}. Notice that the peak occurs where I_{bias}=1.05 amps and this is approximately mid-way between I_{bias}=0.8 amps that produced the maximum open-circuit voltage and I_{bias}=1.3 amps that produced the maximum useable short-circuit current.

A fortuitous discovery was that the power output was larger than expected. Usually the maximum output power in linear systems is when the output voltage is one-half of the open-circuit voltage and the output current is one-half of the short-circuit current. However, the measured power was found to be, unexpectedly, almost twice that amount.

### COST

Due to the simplicity of the rotor and the greatly reduced number of stator windings, costs associated with the manufacture, assembly, maintenance, and repair of structures according to the present invention are expected to be lower than costs associated with CEPGs.

Large CEPGs have a major problem with shipping. Many such generators are so massive that they won't fit on roads or bridges. They cannot be disassembled and broken down into smaller sections for transport because of the nature of their construction and wiring. A huge advantage of the present invention is that each of the stator segments may be shipped separately and readily reassembled on site. The rotor too is so simple that it can be disassembled, shipped, and reassembled on site.

### Applications

Because of its simplicity, potentially low cost, and improved reliability, almost any application can benefit from this invention.

Windmills are a particularly good application because there are no windings on the rotor to throw at high speed. Furthermore, by utilizing a very large number of poles, it may be possible to eliminate the gear-box which is expensive, unreliable, noisy, vibration prone, inefficient, heavy, prone to high maintenance requirements, and incredibly difficult to service. With a large number of poles, the windmill could produce 60 Hz (or 50 Hz) power, even with slow rotating blades. Furthermore, the number of poles could be optimized to find the frequency at which the efficiency is maximized. In this case, the windmill would produce high-voltage DC utilizing bridge rectifiers to connect to a high voltage common DC power line. The rectifiers would isolate the windmill in case of a problem. A centralized DC to 60 Hz AC converter could support the entire wind farm.

Another ideal application is for large fixed generators operating off of water power or steam produced by nuclear, coal, oil, natural gas, diesel, bio-mass, or any other source. Very high efficiency and simplicity are key attributes of the present invention.

Auto alternators are another suitable application area due to having no windings to throw at high speed. The potential lack of permanent magnets could result in a lower cost of manufacture. Additional applications may include, but are not limited to, portable generators, aircraft, submarines, any boat/ship with electric drive, diesel-electric locomotives, co-generation facilities, windmills, water turbines, tidal turbines, automobile alternators, etc.

The above applications are provided by way of example only and are not limiting in nature. Many other applications can take advantage of the numerous benefits of this invention.

Although preferred embodiments of the present invention have been described, it should be evident to anyone skilled in the art that other configurations can be used that fall within the scope of the present invention. For example, other kinds of wire could be used rather than copper, or strips could be used instead of wire. For example, the rotor could be placed on the outside and the stator on the inside. For example, instead of laminations, injectable soft magnetic material could be used. For example, although most of the embodiments were for single phase or three phase outputs, additional phases could readily be accomplished. This could be advantageous for HVDC generation. For example, superimposing the bias on the output windings can also work with CEPG structures. For example, Delta connections may be used in wiring instead of Wye connections. For example, this invention can also apply to motors since it is well known in the art that most generators can be used as motors and some motors can be used as generators. For example, this invention may be used for a linear rather than a rotating generator. For example, although the embodiments and description above utilized square teeth on the rotor and stator, it will be advantageous to tailor the shape of the teeth and the ratio of the tooth width to the tooth pitch for the optimum output waveform and power. For example, designing the bias source for constant flux rather than constant MMF may be advantageous.

These few examples, which are not exhaustive, are merely intended to illustrate some of the many variations that can occur without departing from the spirit of the invention.

1. An alternating current electrical power generator comprising a magnetically conductive rotor substantially free of both a permanent magnet and an electromagnet.

2. The generator of claim 1, wherein the rotor has a plurality of at least one of radial teeth and axial shorting bars.

3. The generator of claim 2, further comprising a stator having at least one segment with a plurality of radial teeth corresponding to the plurality of at least one of radial teeth and axial shorting bars on the rotor.

4. The generator of claim 3, further comprising an air gap interposed between the rotor and the stator.

5. The generator of claim 4, further comprising at least one of:
a low reluctance configuration wherein the plurality of at least one of radial teeth and axial shorting bars on the rotor are substantially aligned with the corresponding plurality of radial teeth on the stator segment; and
a high reluctance configuration wherein the plurality of at least one of radial teeth and axial shorting bars on the rotor are substantially unaligned with the corresponding plurality of radial teeth on the stator segment.

6. The generator of claim 1, further comprising at least two flux paths.

7. The generator of claim 1, further comprising a source of magnetomotive force located either inside or external to the stator.

8. The generator of claim 7, wherein the source of magnetomotive force is one of an electromagnet, a permanent magnet, and a superconducting magnet.

9. The generator of claim 1, further comprising a source of magnetomotive force that is self-biased and a superimposed current on at least one stator winding.

10. The generator of claim 9, wherein at least two opposite phase stator windings configured in a series cancel an alternating voltage and a self-bias direct current applies to the stator windings.

11. The generator of claim 1, further comprising unipolar flux.

12. A method of generating electric power using a steered flux electrical power generator.

13. The method of claim 12, further comprising rotating a rotor to direct flux.

14. The method of claim 13, further comprising sequentially increasing and decreasing the size of an air gap between a plurality of at least one of radial teeth and axial shorting bars on a rotor and a corresponding plurality of radial teeth on the stator.

15. The method of claim 14, further comprising:
rotating the plurality of at least one of radial teeth and axial shorting bars on the rotor into alignment and out of alignment with the corresponding plurality of radial teeth on the stator.

16. The method of claim 12, further comprising generating a source of magnetomotive force that is one of external bias and self-bias.

17. The method of claim 12, further comprising:
operating multiple flux paths;
providing multiple offset groupings of a plurality of at least one of radial teeth and axial shorting bars on a rotor and corresponding offset groupings of a plurality of radial teeth on a stator.

18. The method of claim 12, further comprising substantially switching flux from a first path to a second path.

19. The method of claim 12, further comprising modulating flux intensity by varying reluctance.

20. A method of using an alternating current electrical power generator to generate electricity by any one of: steering flux, including the use of one of resistive electromagnets and superconducting magnets located external to a stator, incorporating self-biased magnetomotive force superimposed on a stator winding, and superimposing a direct current bias on a stator by using out-of-phase outputs in a series to cancel the alternating current.
